(19) United States
(12) Patent Application Publication
(10) Pub. No.: US 2025/0103954 A1
(43) Pub. Date: Mar. 27, 2025

(54) SERVER APPARATUS FOR DRIVING ASSISTANCE AND METHOD OF CONTROLLING THE SAME

(71) Applicant: HL KLEMOVE CORP., Incheon (KR)

(72) Inventor: Joonhyup BAE, Gyeonggi-do (KR)

(21) Appl. No.: 18/648,325

(22) Filed: Apr. 26, 2024

(30) Foreign Application Priority Data
Sep. 27, 2023 (KR) 10-2023-0131048

(51) Int. Cl. G06N 20/00

(52) U.S. Cl. CPC G06N 20/00

(57) ABSTRACT

A server apparatus may include a communicator configured to communicate with a vehicle, a storage medium configured to store a machine learning model and training data, and one or more processors connected to the communication circuit and the storage medium. One or more processors are configured to acquire the training data including reference data and labeled data corresponding to the reference data, train a machine learning model using the training data, receive detected data and a detected track corresponding to the detected data from the vehicle through the communicator, evaluate the trained machine learning model using the training data, correct the machine learning model using the detected data and the detected track based on the evaluation result, and output the corrected machine learning model to the vehicle.

### CROSS-REFERENCE TO RELATED APPLICATION

This application claims the benefit from and priority to Korean Patent Application No. 10-2023-0131048, filed on Sep. 27, 2023 in the Korean Intellectual Property Office, the disclosure of which is incorporated herein by reference herein in its entirety.

### BACKGROUND

### 1. Field

Some embodiments of the present disclosure generally relate to a server apparatus for assisting driving of a vehicle, and a method of controlling the same.

### 2. Description of the Related Art

Vehicles are the most common transportation in modern society, and the number of people using the vehicles is increasing. Although there are advantages such as easy long-distance traveling and convenience of living with the development of a vehicle technology, a problem that road traffic conditions deteriorate and traffic congestion becomes serious in densely populated places often occurs.

Recently, research on vehicles equipped with an advanced driver assist system (ADAS) for actively providing information about a vehicle state, a driver state, and/or a surrounding environment in order to reduce a driver's burden, provide assistance in driving a vehicle, and enhance convenience has been actively conducted.

Examples of the ADAS mounted to vehicles include lane departure warning (LDW), lane keeping assist (LKA), high beam assist (HBA), autonomous emergency braking (AEB), traffic sign recognition (TSR), adaptive cruise control (ACC), blind spot detection (BSD), and the like.

The ADAS may collect information or data about an external environment of the vehicle and process the collected information. In addition, the ADAS may recognize objects and design a route for the vehicle to travel based on a result of processing the collected information or data.

The ADAS may include a sensor module such as a camera or radar and may acquire information about one or more objects around or outside the vehicle by fusing detected data collected by each of the camera and the radar.

Recently, the ADAS may use a light detection and ranging (LiDAR) as well as the camera and the radar to fuse the detected data collected by each of the camera, the radar, and the LiDAR in order to assist driving.

### SUMMARY

It is an aspect of the present disclosure to provide a server apparatus for driving assistance, which can acquire object information from light detection and ranging (LiDAR) data using a machine learning model, and a method of controlling the same.

It is another aspect of the present disclosure to provide a server apparatus for driving assistance, which may train a machine learning model using image data, radar data, LiDAR data, and/or sensor fusion data, and a method of controlling the same.

It is still another aspect of the present disclosure to provide a server apparatus for driving assistance, which can acquire object information from LiDAR data using a machine learning model trained using image data, radar data, LiDAR data, and/or sensor fusion data, and a method of controlling the same.

Additional aspects of the disclosure will be set forth in part in the description which follows and, in part, will be obvious from the description, or may be learned by practice of the disclosure.

In accordance with one aspect of the present disclosure, there is provided a server apparatus including a communication circuit configured to communicate with a vehicle, a storage medium configured to store first and second machine learning models and first and second training data, and a processor electrically connected to the communication circuit and the storage medium. The processor acquires the second training data including reference data and reference labeled data corresponding to the reference data, train the second machine learning model using the second training data, receives detected data and a detected track corresponding to the detected data from the vehicle through the communication circuit, corrects the trained second machine learning model using the detected data and the detected track, acquires the first training data using the corrected second machine learning model, trains the first machine learning model using the first training data, and provides the trained first machine learning model to the vehicle.

The processor may input the reference data to the second machine learning model, acquire first labeled data corresponding to the reference data from the second machine learning model, and train the second machine learning model to decrease an error between the first labeled data and the reference labeled data.

The processor may input the reference data to the trained second machine learning model, acquire evaluation labeled data corresponding to the reference data from the trained second machine learning model, and correct the trained second machine learning model when an error between the evaluation labeled data and the reference labeled data is larger than a reference error.

The processor may acquire the first training data using the trained second machine learning model when the error between the evaluation labeled data and the reference labeled data is smaller than or equal to the reference error.

The processor may input the detected data to the trained second machine learning model, acquire correction labeled data corresponding to the detected data from the trained second machine learning model, and correct the trained second machine learning model to decrease a correction error between the correction labeled data and the detected track.

The processor may adjust the correction error based on the evaluation error.

The processor may adjust the correction error so that the correction error increases as the evaluation error increases, and the correction error decreases as the evaluation error decreases.

In accordance with another aspect of the present disclosure, there is provided a method of controlling a server apparatus including a communication circuit configured to communicate with a vehicle and a storage medium configured to store first and second machine learning models and first and second training data, which includes acquiring the second training data including reference data and reference labeled data corresponding to the reference data, training the second machine learning model using the second training data, receiving detected data and a detected track corresponding to the detected data from the vehicle through the communication circuit, correcting the trained second machine learning model using the detected data and the detected track, acquiring the first training data using the corrected second machine learning model, training the first machine learning model using the first training data, and providing the trained first machine learning model to the vehicle.

The training of the second machine learning model may include inputting the reference data to the second machine learning model, acquiring first labeled data corresponding to the reference data from the second machine learning model, and training the second machine learning model to decrease an error between the first labeled data and the reference labeled data.

An evaluation of the second machine learning model may include inputting the reference data to the trained second machine learning model, acquiring evaluation labeled data corresponding to the reference data from the trained second machine learning model, and correcting the trained second machine learning model when an error between the evaluation labeled data and the reference labeled data is larger than a reference error.

The method may further comprise acquiring the first training data using the trained second machine learning model when the error between the evaluation labeled data and the reference labeled data is smaller than or equal to the reference error.

The correcting of the second machine learning model may include inputting the detected data to the trained second machine learning model, acquiring correction labeled data corresponding to the detected data from the trained second machine learning model, and correcting the trained second machine learning model to decrease a correction error between the correction labeled data and the detected track.

The correcting of the second machine learning model may include adjusting the correction error based on the evaluation error.

The adjusting of the correction error may include adjusting the correction error so that the correction error increases as the evaluation error increases, and the correction error decreases as the evaluation error decreases

In accordance with still another aspect of the present disclosure, there is provided a server apparatus including a communication circuit configured to communicate with a vehicle, a storage medium configured to store a machine learning model and training data, and a processor electrically connected to the communication circuit and the storage medium. The processor acquires the training data including reference data and labeled data corresponding to the reference data, trains the machine learning model using the training data, receives detected data and a detected track corresponding to the detected data from the vehicle through the communication circuit, evaluates the trained machine learning model using the training data, corrects the machine learning model using the detected data and the detected track based on the evaluation result, and provides the corrected machine learning model to the vehicle.

The processor may input the reference data to the machine learning model, acquire a training track corresponding to the reference data from the machine learning model, and train the machine learning model to decrease an error between the training track and the labeled data.

The processor may input the reference data to the trained machine learning model, acquire an evaluated track corresponding to the reference data from the trained machine learning model, and correct the trained machine learning model when an error between the evaluated track and the labeled data is larger than a reference error.

The processor may input the detected data to the trained machine learning model, acquire a corrected track corresponding to the detected data from the trained machine learning model, and correct the trained machine learning model to decrease a correction error between the corrected track and the detected track.

The processor may adjust the correction error based on the evaluation error.

The processor may adjust the correction error so that the correction error increases as the evaluation error increases, and the correction error decreases as the evaluation error decreases.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic diagram for illustrating a driving assistance system according to an embodiment of the present disclosure;

FIG. 2 is a block diagram for illustrating a configuration of a vehicle including a driving assistance apparatus according to an embodiment of the present disclosure;

FIG. 3 illustrates an example of fields of view of sensor modules included in a driving assistance apparatus according to an embodiment of the present disclosure;

FIG. 4 is a block diagram for illustrating a configuration of a server apparatus according to an embodiment of the present disclosure;

FIG. 5 is a view illustrating an example in which light detection and ranging (LiDAR) data and fusion data are matched;

FIG. 6 is a view illustrating an example in which a server apparatus adjusts an error between an output of a machine learning model and training data according to an embodiment of the present disclosure;

FIG. 7 is a flowchart for illustrating a method of training a machine learning model according to an embodiment of the present disclosure;

FIG. 8 is a flowchart for illustrating a method of labeling training data for training a machine learning model according to an embodiment of the present disclosure; and

FIG. 9 is a flowchart for illustrating a method of labeling training data for training a machine learning model according to an embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

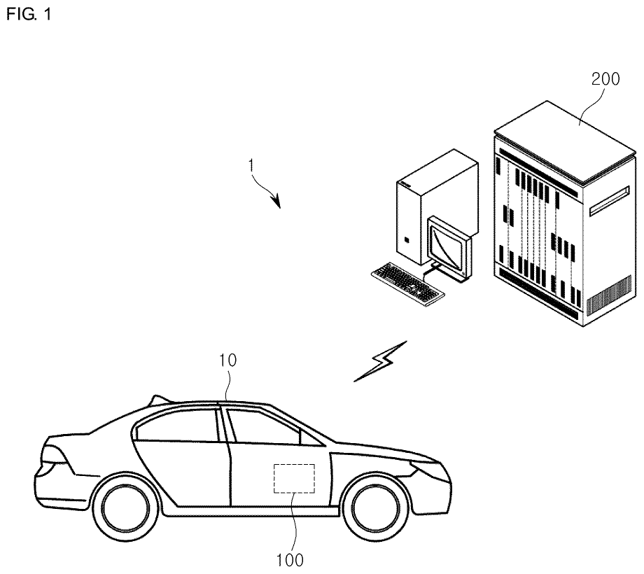

FIG. 1 is a schematic diagram for illustrating a driving assistance system according to an embodiment of the present disclosure.

Referring to FIG. 1, a driving assistance system 1 may include a driving assistance apparatus 100 mounted to or included in a vehicle 10 and a server apparatus 200.

The vehicle 10 may travel on a road or track using fossil fuel, electricity, or any power source. The vehicle 10 may include the driving assistance apparatus 100 for assisting a driver's driving or assisting driving of the vehicle 10.

The driving assistance apparatus 100 may include a sensor module for detecting data about at least one object positioned outside or located around the vehicle 10. The driving assistance apparatus 100 may process the detected data from the sensor module and acquire a track representing the object outside or around the vehicle based on the processed detected data. For example, the driving assistance apparatus 100 may acquire an image track by processing image data, acquire a radar track by processing radar data, and acquire a light detection and ranging (LiDAR) track by processing LiDAR data.

The image track, the radar track, or the LiDAR track may each represent at least one object outside or around the vehicle 10. Information about the image track, the radar track, or the LiDAR track may include, for example, but not limited to, a position (e.g., a distance and an orientation angle) of at least one object outside or around the vehicle 10, a size of the at least one object outside or around the vehicle 10, a speed (e.g., a relative speed with respect to the vehicle 10) of the at least one object, or a classification or kind (e.g., a stationary object, a vehicle, a pedestrian, or a cyclist) of at least one object outside the vehicle 10.

The information about the detected data (e.g., the image data, the radar data, or the LiDAR data) of the sensor module and/or the track (e.g., the image track, the radar track, or the LiDAR track) may be provided to the server apparatus 200. For example, the information about the detected data of the sensor module and/or the track may be provided to the server apparatus 200 in real time through a wireless communication system of the vehicle 10. As another example, the information about the detected data of the sensor module and/or the track may be provided to the server apparatus 200 after the vehicle 10 is parked (or immediately after parked) or at predetermined times. As still another example, the information about the detected data of the sensor module and/or the track may be stored at a storage medium and provided to the server apparatus 200 through the storage medium.

The server apparatus 200 may include a first machine learning model for outputting the image track, the radar track, the LiDAR track, and/or a fusion track from the image data, the radar data, and/or the LiDAR data.

A machine learning model may be, for example, an algorithm or model for obtaining the relationship or function between input and output data through learning (or training) with many pieces of input and output data and automatically outputting output data corresponding to input data using the obtained relationship or function between the input and output data. The machine learning model may include, for example, a deep learning model but is not limited thereto. The deep learning model may be a machine learning model using an artificial neural network structure (or an artificial neural network algorithm), which is a human logical structure. For instance, the deep learning model may include, for example, a convolutional neural network (CNN), a recurrent neural network (RNN), a generative adversarial network (GNN), reinforcement learning (RL), or the like, but is not limited thereto.

For example, when at least one of the image data, the radar data, and/or the LIDAR data is input to the server apparatus 200, the first machine learning model of the server apparatus 200 may output at least one of the image track, the radar track, the LiDAR track, and/or the fusion track corresponding to the input detected data. For example, the first machine learning model may output the LiDAR track when the LiDAR data is input, or output the image track when the image data is input. In addition, the first machine learning model may output the image and radar fusion track when the image data and the radar data are input.

The server apparatus 200 may further include first training data for training the first machine learning model. For example, the first training data may include labeled detected data. The labeled detected data may include labeled image data, labeled radar data, and/or labeled LiDAR data. The labeled detected data may include the detected data (e.g., the image data, the radar data, or the LiDAR data) and labeled data representing a position, a size, and/or a classification of the track.

For example, when the LiDAR data among the first training data is input, the first machine learning model may output the LiDAR track corresponding to the LiDAR data. The output LiDAR track may be compared with the labeled data, and the first machine learning model may be modified or updated based on a training error between the LiDAR track and the labeled data. For example, the first machine learning model may be modified or updated to decrease the training error between the LiDAR track output from the first machine learning model and the labeled data included in the first training data. The first machine learning model may be trained in such an exemplary manner.

In the above description, the machine learning model, such as, the first machine learning model, has been used to acquire the image track, the radar track, and/or the fusion track, but the present disclosure is not limited thereto. For example, the server apparatus 200 may use an application program (hereinafter referred to as “conventional program”) rather than the machine learning model in order to acquire the image track, the radar track, and/or the fusion track. The conventional program may output output data corresponding to input data according to a predetermined relationship or function between input data and output data without obtaining the relationship or function between the input data and the output data using training data.

The server apparatus 200 may further include a second machine learning model for generating first training data.

The second machine learning model may output labeled data corresponding to the input detected data (e.g. the image data, the radar data, or the LiDAR data).

The second machine learning model may be trained by second training data including reference detected data and reference labeled data. Conventionally, a labeling operation of acquiring reference labeled data from detected data was performed by humans, but the labeling operation by humans required to take a lot of time and cost.

In order to reduce the cost and time, the server apparatus 200 may perform the labeling operation using the second machine learning model.

The server apparatus 200 may further include the second training data for training the second machine learning model.

The second training data may include the reference detected data provided by the labeling operation of humans and the reference labeled data corresponding thereto.

The server apparatus 200 may train the second machine learning model using the second training data. For example, the server apparatus 200 may input the reference detected data into the second machine learning model and acquire first labeled data corresponding to the reference detected data from the second machine learning model. The server apparatus 200 may compare the first labeled data with the reference labeled data and modify or update the second machine learning model according to an error resulting from the comparison. For example, the second machine learning model may be modified or updated to decrease an error between the first labeled data and the reference labeled data. The second machine learning model may be trained in such an exemplary manner.

In this case, since the second training data may be provided through the labeling operation of humans, the number of pieces of second training data may be insufficient. Therefore, there are limits to the reliability and labeling accuracy of the trained second machine learning model.

The server apparatus 200 may correct the second machine learning model using the information about the detected data and/or the track collected from the vehicle 10 in order to improve the reliability and labeling accuracy of the trained second machine learning model.

For example, the server apparatus 200 may acquire the LiDAR data and the fusion track (e.g., a track obtained by fusing data received from a plurality of sensors such as the image data and the radar data) from the vehicle 10. The server apparatus 200 may input the LiDAR data to the second machine learning model, and the second machine learning model may output corrected labeled data corresponding to the input LIDAR data. The corrected labeled data may be compared with the fusion track acquired from the vehicle 10, and the trained second machine learning model may be corrected according to the error resulting from the comparison. The corrected second machine learning model may have further improved reliability and accuracy.

The first machine learning model trained by the first training data may be provided to or included in the vehicle 10. For example, the first machine learning model may be provided to or included in a vehicle (e.g., a new vehicle that has not yet been shipped or sold) in which the machine learning model has not been previously installed. As another example, the first machine learning model may be provided to or included in a vehicle (e.g., a vehicle that has already been sold or shipped) in which the machine learning model has been previously installed. In other words, the machine learning model already installed in the vehicle may be renewed as the newly trained first machine learning model.

In the above description, the server apparatus 200 including the first machine learning model for generating a track and the second machine learning model for labeling has been described. However, the server apparatus 200 according to the present disclosure is not limited thereto.

For example, the server apparatus 200 may include one machine learning model for generating a track corresponding to detected data and training data for training a machine learning model. The server apparatus 200 may train the machine learning model using the training data.

The server apparatus 200 may receive the detected data (e.g., the image data, the radar data, or the LiDAR data) and the track (e.g., the image track, the radar track, the LiDAR track, or the fusion track) from the vehicle 10. For example, the server apparatus 200 may receive the LiDAR data and the image and radar fusion track (e.g., a track obtained by fusing the image data and the radar data) from the vehicle 10.

The server apparatus 200 may correct the trained machine learning model using the data and the track received from the vehicle 10.

The LiDAR data may be input to the trained machine learning model, and the trained machine learning model may output the LiDAR track corresponding to the LiDAR data. The output LiDAR track may be compared with the fusion track, and the machine learning model may be corrected based on the error between the LiDAR track and the fusion track. For example, the trained machine learning model may be corrected to reduce the error between the LiDAR track and the fusion track.

The trained machine learning model (or the first machine learning model) may be provided to or included in the driving assistance apparatus 100 of the vehicle 10. The driving assistance apparatus 100 may acquire a track representing at least one object outside or around the vehicle 10 from the image data, the radar data, and/or the LiDAR data using the trained machine learning model (or the first machine learning model). In other words, the trained machine learning model may output the image track, the radar track, and/or the LiDAR track when the image data, the radar data, and/or the LiDAR data are input.

As described above, the driving assistance apparatus 100 of the vehicle 10 may acquire a track representing at least one object outside or around the vehicle 10 from at least one of the image data, the radar data, and/or the LiDAR data using the trained machine learning model. At this time, at least one of the image data, the radar data, and/or the LiDAR data collected by the driving assistance apparatus 100 and information about the track corresponding thereto may be provided to the server apparatus 200.

The server apparatus 200 may acquire information about at least one of the image data, the radar data, and/or the LiDAR data and information about the track corresponding thereto and train the machine learning model using the acquired data and the track corresponding thereto. The newly trained machine learning model may be provided to the vehicle 10.

It has been described above that the driving assistance apparatus 100 acquires the information about the object using the trained machine learning model and the server apparatus 200 trains the machine learning model, but the present disclosure is not limited thereto. For example, the driving assistance apparatus 100 may transmit at least one of the image data, the radar data, and/or the LiDAR data to the server apparatus 200, and the server apparatus 200 may not only train the machine learning model but also acquire information about the object using the trained machine learning model, and transmit the information about the object to the driving assistance apparatus 100. As another example, the driving assistance apparatus 100 may not only acquire the information about the object using the trained machine learning model but also train the machine learning model.

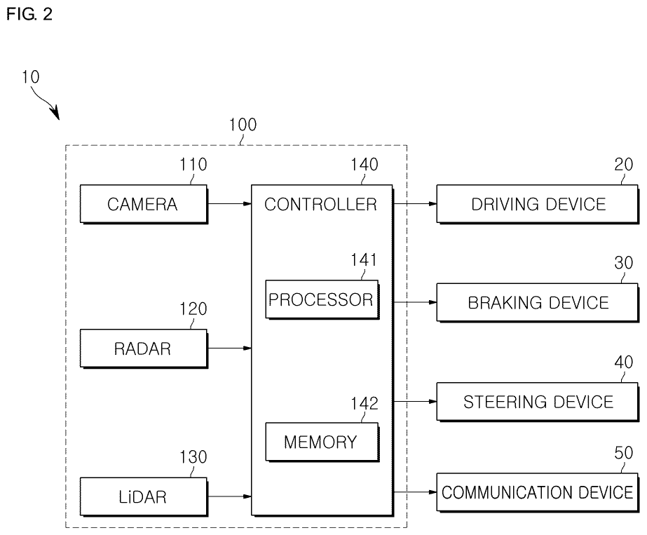

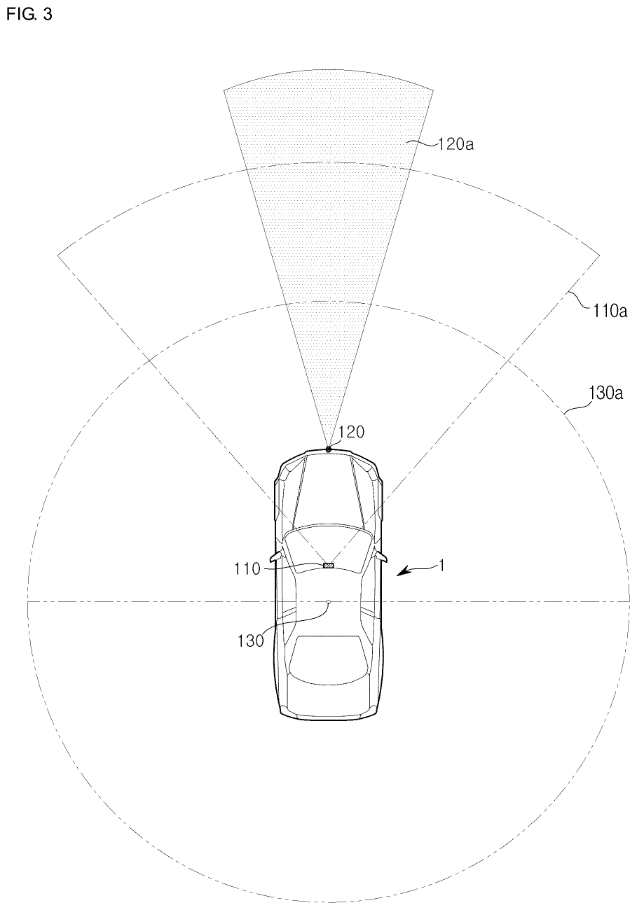

FIG. 2 is a block diagram for illustrating a configuration of a vehicle including a driving assistance apparatus according to an embodiment of the present disclosure. FIG. 3 illustrates an example of fields of view of sensor modules included in a driving assistance apparatus according to an embodiment of the present disclosure.

Referring to FIG. 2, the vehicle 10 may include a driving device 20, a braking device 30, a steering device 40, and/or the driving assistance apparatus 100. Optionally, the vehicle 10 may further include a communication device 50. The driving device 20, the braking device 30, the steering device 40, and/or the driving assistance apparatus 100 may communicate with one another via a vehicle communication network. For example, the electric devices 20, 30, 40, and 100 included in the vehicle 10 may transmit or receive data via the communication network such as Ethernet, media oriented systems transport (MOST), Flexray, controller area network (CAN), local interconnect network (LIN), or the like.

The driving device 20 may supply power for driving the vehicle 10 to travel and, for example, move or accelerate the vehicle 10, in response to a driver's intention or a controller of the vehicle 10 to accelerate through an accelerator pedal or a request of the driving assistance apparatus 100.

The braking device 30 may provide a braking force for the vehicle 10 to brake the vehicle 10 and, for example, decelerate or stop the vehicle 10, in response to a driver's intention or a controller of the vehicle 10 to brake through a brake pedal and/or a request of the driving assistance apparatus 100.

The steering device 40 may steer the vehicle 10 or change a traveling direction of the vehicle 10 in response to a driver's steering intention and/or a signal from a controller of the vehicle 10 through a steering wheel and/or the driving assistance apparatus 100.

The communication device 50 may be optionally provided or included in the vehicle 10. The communication device 50 may exchange or communicate data with the server apparatus 200 wirelessly or by wire. For example, the communication device 50 may wirelessly transmit data to a base station or access repeater, and data may be transmitted from the base station or access repeater to the server apparatus 200 by wire. In addition, the server apparatus 200 may transmit data to the base station or access repeater by wire, and data may be wirelessly transmitted from the base station or access repeater to the communication device 50.

The driving assistance apparatus 100 may communicate with the driving device 20, the braking device 30, and the steering device 40 via the vehicle communication network.

The driving assistance apparatus 100 may provide various functions for driving assistance and safety enhancement. For example, the driving assistance apparatus 100 may be configured to provide one or more functions of lane departure warning (LDW), lane keeping assist (LKA), high beam assist (HBA), autonomous emergency braking (AEB), traffic sign recognition (TSR), adaptive cruise control (ACC), blind spot detection (BSD), or the like.

The driving assistance apparatus 100 may include, or may be operably associated with, a camera 110, a radar 120, a LIDAR 130, and a controller 140. The camera 110, the radar 120, the LiDAR 130, and the controller 140 may not be essential components of the driving assistance apparatus 100. For example, at least one of the camera 110, radar 120, and LiDAR device 130 may be omitted from or may not be included in the driving assistance apparatus 100 illustrated in FIG. 2, or any detector or sensor capable of detecting or sensing external objects of the vehicle 10 may be added to the vehicle 10 or the driving assistance apparatus 100.

The camera 110, the radar 120, the LiDAR 130, and the controller 140 may be provided separately from one another. For example, the controller 140 may be installed in a housing separated from a housing of the camera 110, a housing of the radar 120, and a housing of the LiDAR 130. The controller 140 may exchange data with the camera 110, the radar 120, and/or the LiDAR 130 via a broad-bandwidth network.

The camera 110 may capture an outward view of the vehicle 10 and acquire image data for the outward view of the vehicle 10. For example, as illustrated in FIG. 3, the camera 110 may be installed on, or adjacent to, a front windshield of the vehicle 10 and may have a forward field of view 110a of the vehicle 10, although not required.

For instance, the camera 110 may include a plurality of lenses and an image sensor. The image sensor may include a plurality of photodiodes for converting light into electrical signals, and the plurality of photodiodes may be disposed in the form of a two-dimensional matrix.

The camera 110 may optionally include an image processor for processing image data and identify an object outside or around the vehicle 10 based on the processing of the image data. The camera 110 may, for example, generate a track representing an object based on the processed image data and classify the track. For example, the camera 110 may identify whether the track is another vehicle, a pedestrian, an animal, a cyclist, or the like. The camera 110 may acquire an image track representing an external object from the image data using, for example, the machine learning model.

The camera 110 may be electrically or communicationally connected to the controller 140. For example, the camera 110 may be connected to the controller 140 via the vehicle communication network, connected to the controller 140 via a hard wire, or connected to the controller 140 through a conductive line of a printed circuit board (PCB). The camera 110 may provide information about the image data or image track for the outward view of the vehicle 10 to the controller 140. The information about the image track may include information related to positions of objects outside or around the vehicle 10 (e.g., information related to distances and/or angles of objects), information regarding sizes of objects, and/or classification of objects.

The radar 120 may transmit transmission radio waves to the outside of the vehicle 10 and identify external objects of the vehicle 10 based on reflected radio waves reflected from the external objects. For example, as illustrated in FIG. 3, the radar 120 may be installed on a grille or bumper of the vehicle 10 and may have a forward sensing area 120a of the vehicle 10, although not required.

The radar 120 may include one or more transmission antennas (or a transmission antenna array) for transmitting or radiating transmission radio waves to the outside of the vehicle 10 and one or more reception antennas (or a reception antenna array) for receiving reflected radio waves reflected from one or more objects.

The radar 120 may acquire radar data from the transmission radio waves transmitted by the transmission antenna and the reflected radio waves received by the reception antenna.

The radar 120 may include a signal processor configured to process the radar data and generate a track representing the object by clustering reflection points by the reflected radio waves. The radar 120 may acquire a radar track representing the external object from the radar data using, for example, the machine learning model.

The radar 120 may be connected to the controller 140 via the vehicle communication network, a hard wire, or a conductive line of the PCB and transmit information about the radar data or radar track to the controller 140. The information about the radar track may include position information regarding objects outside or around the vehicle 10 (e.g., information related to distances and/or angles of objects) and/or information related to the size of the objects.

The LiDAR 130 may emit light (e.g., infrared rays) toward the outside of the vehicle 10 and detect external objects of the vehicle 10 based on reflected light reflected from the external objects. For example, as illustrated in FIG. 3, the LiDAR 130 may be installed on a roof or windshield of the vehicle 10 and may have a sensing area 130a in all directions outside the vehicle 10.

The LiDAR 130 may include a light source (e.g., a light emitting diode, a light emitting diode array, a laser diode, or a laser diode array) configured to emit light (e.g., infrared rays) and an optical sensor (e.g., a photodiode or a photodiode array) configured to receive light. In addition, as necessary, the LiDAR 130 may further include a driving device configured to rotate or move the light source and/or the optical sensor.

The LiDAR 130 may emit light through or by the light source and receive the light reflected from objects through or by the optical sensor, thereby acquiring LiDAR data.

The LiDAR 130 may include a signal processor configured to process the LIDAR data and generate a track representing the object by clustering reflection points by the reflected radio waves. The LiDAR 130 may acquire a LiDAR track representing the external object from the LiDAR data using, for example, the machine learning model.

The LiDAR 130 may be connected to the controller 140 via the vehicle communication network, a hard wire, or the PCB and transmit information about the LIDAR data or LiDAR track to the controller 140. Information about the LiDAR track may include positions of the external objects of the vehicle 10 (e.g. distances and/or directions of the external objects), sizes of the external objects, and/or classification or type of the external objects.

The controller 140 may be electrically or communicationally connected to the camera 110, the radar 120, and/or the LiDAR 130. In addition, the controller 140 may be connected to the driving device 20, the braking device 30, and the steering device 40 via the vehicle communication network.

The controller 140 may receive the image data (or the information about the image track) of the camera 110, the radar data (or the information about the radar track) of the radar 120, and the LiDAR data (or the information about the LiDAR track) of the LiDAR 130 and provide control signals to the driving device 20, the braking device 30, and/or the steering device 40.

The controller 140 may include a processor 141 and a memory 142.

The processor 141 may process the image data (or the image track) of the camera 110, the radar data (or the radar track) of the radar 120, and/or the LiDAR data (or the LiDAR track) of the LiDAR 130.

For example, the processor 141 may include an image processor configured to process the image data of the camera 110, one or more signal processors configured to process the radar data of the radar 120, and/or the LiDAR data of the LIDAR 130, and/or a micro control unit (MCU) configured to generate control signals such as driving, braking, and steering signals. The image processor, the signal processor, and/or the MCU may not be essential components of the processor 141, and one or more among them may be omitted from or may not be included in the processor 141.

For example, the processor 141 may receive the image data of the camera 110, the radar data of the radar 120, and/or the LiDAR data of the LiDAR 130. The processor 141 may process the image data, the radar data, and/or the LiDAR data using the trained machine learning model and acquire the information related to the object (e.g., a position, a size, a speed, a classification, and the like of the external object) based on a result of processing the data. Based on the information about the object, the processor 141 may generate control signals, for example, but not limited to, a driving signal, a braking signal, and/or a steering signal for controlling the driving device 20, the braking device 30, and/or the steering device 40, respectively.

As another example, the processor 141 may receive information about the image track of the camera 110, information about the radar track of the radar 120, and/or information about the LiDAR track of the LiDAR 130. The processor 141 may acquire the information about the object by fusing two or more of the image track, the radar track, and/or the LiDAR track.

As another example, the processor 141 may receive the information about the image track of the camera 110, the information about the radar track of the radar 120, and/or the information about the LiDAR data of the LiDAR 130. The processor 141 may acquire the LiDAR track from the LiDAR data using the trained machine learning model. In addition, the processor 141 may acquire sensor fusion data by fusing the image track and the radar track and acquire information about the object based on the sensor fusion data and the LiDAR track.

The processor 141 may generate a driving signal, a braking signal, and/or a steering signal for evading the object based on the information about the object.

The memory 142 may store programs, instructions and/or data for the processor 141 to process the image data (or the image track), the radar data (or the radar track), and/or the LiDAR data (or the LiDAR track). The memory 142 may also store programs, instructions, and/or data for the processor 141 to generate the driving, braking, and steering control signals.

In addition, the memory 142 may temporarily store the image data (or the image track), the radar data (or the radar track), and/or the LiDAR data (or the LiDAR track) and temporarily store processed data which is a result of processing the image data (or the image track), the radar data (or the radar track), and/or the LiDAR data (or the LiDAR track) of the processor 141.

For example, the memory 142 may include not only volatile memories such as a static random access memory (SRAM) and a dynamic RAM (DRAM) but also non-volatile memories such as a read only memory (ROM) and an erasable programmable ROM (EPROM).

The controller 140 may store at least one of the image data, the radar data, and/or the LiDAR data and the information about the object in the memory 142. For example, the controller 140 may store the LiDAR data and the information about the object (e.g., the fusion data obtained by fusing the image track and the radar track) in the non-volatile memory such as a flash memory.

In addition, the controller 140 may provide at least one of the image data, the radar data, and/or the LiDAR data and the information about the object to the server apparatus 200 through the communication device 50 of the vehicle 10. For example, the controller 140 may transmit the LiDAR data and the information about the object (e.g., the fusion data obtained by fusing the image track and the radar track) to the server apparatus 200 through the communication device 50 of the vehicle 10. The controller 140 may transmit the LiDAR data and the information about the object to the server apparatus 200 in real time or transmit the LiDAR data and the information about the object to the server apparatus 200 after the vehicle 10 is parked or at predetermined times.

As described above, the controller 140 may provide the driving signal, the braking signal, and/or the steering signal based on the image data (or the image track), the radar data (or the radar track), and/or the LiDAR data (or the LiDAR track). In addition, the controller 140 may store at least one of the image data, the radar data, and/or the LiDAR data and the information about the object or provide the at least one of the image data, the radar data, and/or the LiDAR data and the information about the object to the server apparatus 200.

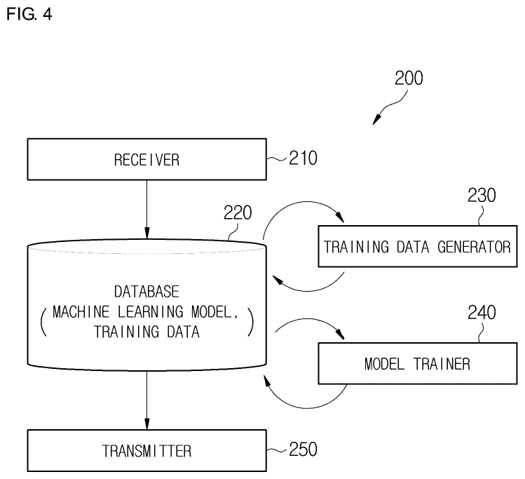

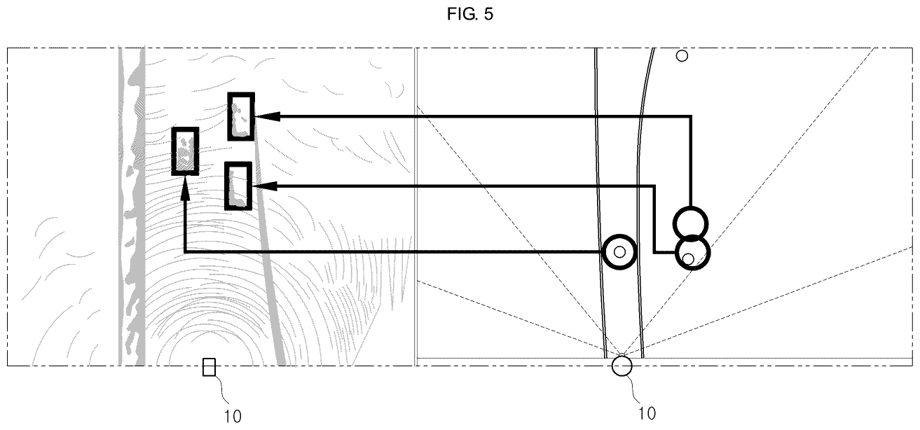

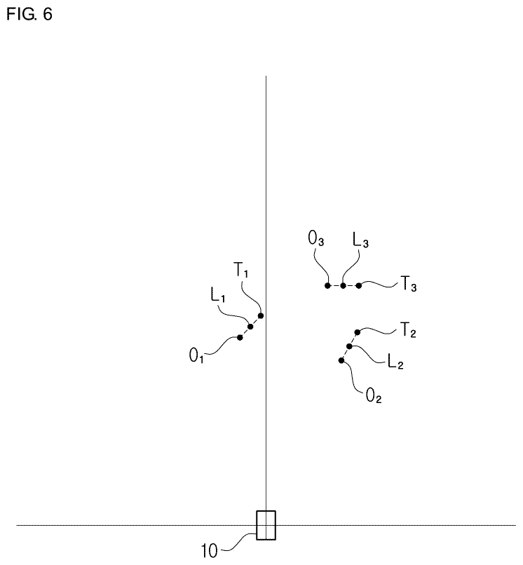

FIG. 4 is a block diagram for illustrating a configuration of a server apparatus according to an embodiment of the present disclosure. FIG. 5 is a view illustrating an example in which light detection and ranging (LiDAR) data and fusion data are matched. FIG. 6 is a view illustrating an example in which a server apparatus adjusts an error between an output of a machine learning model and training data according to an embodiment of the present disclosure.

The server apparatus 200 may include the first machine learning model configured to output a track (e.g. an image track, a radar track, a LiDAR track, and/or a fusion track) corresponding to data detected by an image sensor, a radar, and/or a LIDAR (e.g. the image data, the radar data, and/or the LiDAR data), and the first training data for training the first machine learning model. The first training data may include at least one of the image data, the radar data, and/or the LiDAR data and labeled data corresponding thereto.

In addition, the server apparatus 200 may include the second machine learning model for generating the first training data and the second training data for training the second machine learning model. The second training data may include the detected data (e.g. the image data, the radar data, or the LiDAR data) and the reference labeled data corresponding thereto. The reference labeled data may include information about the track obtained from the detected data (e.g., a position and/or a size of the track).

The server apparatus 200 may correct the second machine learning model trained by the second training data using the detected data (e.g. the image data, the radar data, and/or the LiDAR data) and/or the tracks (e.g. the image track, the radar track, and/or the fusion track) acquired from the vehicle 10. For example, the server apparatus 200 may correct the trained second machine learning model using the LIDAR data and an image and radar fusion track (i.e. a track obtained by fusing the image data and the radar data) acquired from the vehicle 10.

For example, as illustrated in FIG. 4, the server apparatus 200 may include a receiver 210, a database 220, a training data generator or training data generating module 230, a model trainer or model training module 240, and a transmitter 250. The receiver 210, the database 220, the training data generator 230, the model trainer 240, and the transmitter 250 may not be essential components of the server apparatus 200, and one or more of the components may be omitted from or may not be included in the server apparatus 200. The receiver 210 and the transmitter 250 may be implemented as a transceiver, communicator, or communication circuit, and the database 220 may be implemented as a memory or storage medium. The training data generator 230 and the model trainer 240 may be implemented as at least one processor or software modules stored in the memory and configured to be executable by at least one processor.

The receiver 210 may acquire the detected data (the image data, the radar data, and/or the LiDAR data) and the track (the image track, the radar track, the LiDAR track, and/or the fusion track) of the vehicle 10. For example, the receiver 210 may be implemented as a transceiver, communicator, or communication device and may receive the data and the track from the vehicle 10 through a broadband communication network. As another example, the receiver 210 may be implemented as a data reader and may read the data and tracks of the vehicle 10 from the storage medium in which the data and tracks of the vehicle 10 are stored.

The database 220 may store the machine learning model and the training data. The machine learning model may include the first machine learning model and the second machine learning model, and the training data may include the first training data and the second training data.

When the image data, the radar data, and/or the LiDAR data are input to the first machine learning model, the first machine learning model may output the image track, the radar track, the LiDAR track, and/or the fusion track corresponding to the input detected data.

The first training data may be data for training the first machine learning model. The first training data may include labeled detected data. The labeled detected data may include, for example, but not limited to, labeled image data, labeled radar data, and/or labeled LiDAR data. The labeled image data may include image data and labeled data representing information about the track corresponding to the image data. The labeled radar data may include radar data and labeled data representing information about a track corresponding to the radar data. The labeled LiDAR data may include LiDAR data and labeled data representing the information about a track corresponding to the LiDAR data.

The second machine learning model may generate the first training data corresponding to the image data, the radar data, and/or the LiDAR data. For example, when the image data, the radar data, and/or the LiDAR data are input to the second machine learning model, the second machine learning model may output the labeled data corresponding to the input detected data.

The second training data may be data for training the second machine learning model. The second training data may include reference data of at least one of the image data, the radar data, and/or the LiDAR data and reference labeled data corresponding thereto.

The training data generator 230 may generate labeled detected data (e.g., labeled image data, labeled radar data, or labeled LiDAR data) using the second machine learning model stored in the database 220.

The training data generator 230 may input the detected data (e.g. at least one of the image data, the radar data, and/or the LiDAR data) to the second machine learning model and acquire the labeled data from the second machine learning model. The training data generator 230 may acquire the labeled detected data (e.g. the labeled image data, the labeled radar data, or the labeled LiDAR data) having the detected data input to the second machine learning model and the labeled data output from the second machine learning model. For this, the training data generator 230 may combine the detected data input to the second machine learning model with the labeled data output from the second machine learning model. For example, the training data generator 230 may acquire the labeled LiDAR data by combining the LIDAR data with the labeled data.

As described above, the training data generator 230 may acquire the first training data including the labeled image data, the labeled radar data, and/or the labeled LiDAR data from the image data, the radar data, and/or the LiDAR data.

The model trainer 240 may train the first machine learning model and the second machine learning model.

The model trainer 240 may train the first machine learning model using the first training data. The model trainer 240 may input the image data, the radar data, or the LiDAR data to the first machine learning model and acquire the image track, the radar track, or the LiDAR track from the first machine learning model. The model trainer 240 may compare the track output from the first machine learning model with the labeled data of the first training data. The model trainer 240 may modify or update the first machine learning model to reduce the training error between the track output from the first machine learning model and the labeled data.

For example, the model trainer 240 may input the LiDAR data to the first machine learning model and acquire the LiDAR track from the first machine learning model. The model trainer 240 may compare the LiDAR track with the labeled data and modify or update the first machine learning model to reduce the training error between the LiDAR track and the labeled data.

In addition, the model trainer 240 may train the second machine learning model using the second training data. The model trainer 240 may input the image data, the radar data, or the LiDAR data to the second machine learning model and acquire the first labeled data from the second machine learning model. The model trainer 240 may modify or update the second machine learning model to reduce the training error between the first labeled data output from the second machine learning model and the reference labeled data of the second training data.

For example, the model trainer 240 may input the LiDAR data to the second machine learning model and acquire the first labeled data from the second machine learning model. The model trainer 240 may compare the first labeled data of the second machine learning model with the reference labeled data of the second training data and modify or update the second machine learning model to reduce the training error between the first labeled data of the second machine learning model and the reference labeled data of the second training data.

The model trainer 240 may evaluate the trained second machine learning model using the second training data. When the accuracy of the trained second machine learning model is low (for example, if the accuracy of the trained second machine learning model is lower than a preset threshold or reference error), the model trainer 240 may correct the trained second machine learning model using the data and the tracks acquired from the vehicle 10.

For example, the model trainer 240 may input the LiDAR data included in the second training data to the trained second machine learning model and acquire evaluation labeled data from the trained second machine learning model. The model trainer 240 may compare the evaluation labeled data of the trained second machine learning model with the reference labeled data of the second training data and acquire an evaluation error between the evaluation labeled data of the trained second machine learning model and the reference labeled data of the second training data.

The model trainer 240 may compare the acquired evaluation error with a reference error and determine that the accuracy of the trained second machine learning model is high when the acquired evaluation error is smaller than or equal to a reference error. In addition, when the acquired evaluation error is larger than the reference error, the model trainer 240 may determine that the accuracy of the trained second machine learning model is low.

When the acquired evaluation error is larger than the reference error, the model trainer 240 may correct or modify the trained second machine learning model using the detected data and/or the track acquired from the vehicle 10.

For example, the model trainer 240 may correct the trained second machine learning model using the LiDAR data and the image/radar fusion track (e.g., the track obtained by fusing the image data and the radar data) acquired from the vehicle 10.

The model trainer 240 may input the LiDAR data acquired from the vehicle 10 to the trained second machine learning model and receive or acquire corrected labeled data from the trained second machine learning model. The model trainer 240 may compare the labeled data of the trained second machine learning model with the fusion track acquired from the vehicle 10 and correct the trained second machine learning model to reduce a correction error between the corrected labeled data and the fusion track.

For example, the model trainer 240 may acquire the LiDAR data (for example, an image on the left of FIG. 5) and the image and radar fusion track (for instance, an image on the right of FIG. 5). The server apparatus 200 may acquire the LiDAR data, the image data, and the radar data from the vehicle 10 and derive the image and radar fusion track from the image data and the radar data using the first machine learning model or a conventional program.

As illustrated in FIG. 5, the LiDAR data may include multiple points. The model trainer 240 may input the LiDAR data including the multiple points to the second machine learning model and acquire corrected labeled data representing the positions and/or the sizes of the tracks. The model trainer 240 may compare the corrected labeled data of the second machine learning model with the image and radar fusion track as illustrated in FIG. 5. For example, the model trainer 240 may compare the positions and/or the sizes of the tracks by the corrected labeled data with a position and/or a size of the image and radar fusion track and acquire a correction error between the corrected labeled data and the image and radar fusion track.

The model trainer 240 may correct the trained second machine learning model to reduce the correction error.

As described above, the model trainer 240 may compensate the error or lack of the labeled detected data (e.g. the labeled image data, the labeled radar data, or the labeled LiDAR data) using the data and the fusion track acquired from the vehicle 10.

In addition, the model trainer 240 may change a degree of correction using the data and the tracks acquired from the vehicle 10 according to the accuracy of the second machine learning model while correcting the trained second machine learning model.

As described above, the model trainer 240 may evaluate the trained second machine learning model. Specifically, the model trainer 240 may acquire an evaluation error between the evaluation labeled data of the trained second machine learning model and the reference labeled data of the second training data.

The model trainer 240 may change a ratio of correction using the data and the tracks acquired from the vehicle 10 based on the acquired evaluation error. The model trainer 240 may increase the ratio of correction using the detected data and/or the tracks acquired from the vehicle 10 as the acquired evaluation error increases. However, the model trainer 240 may decrease the ratio of correction using the detected data and/or the tracks acquired from the vehicle 10 as the acquired evaluation error decreases.

For example, as described above, the model trainer 240 may input the LiDAR data acquired from the vehicle 10 to the trained second machine learning model and acquire the corrected labeled data from the trained second machine learning model. The model trainer 240 may correct the trained second machine learning model based on the correction error between the corrected labeled data and the fusion track.

At this time, the model trainer 240 may adjust the correction error between the corrected labeled data and the fusion track acquired from the vehicle 10 based on the evaluation error between the previously acquired evaluation labeled data and the reference labeled data. The model trainer 240 may adjust the correction error so that as the evaluation error between the evaluation labeled data and the reference labeled data increases, the correction error between the corrected labeled data and the fusion track acquired from the vehicle 10 increases (e.g., so that the correction error becomes closer to an original error between the corrected labeled data and the fusion track acquired from the vehicle 10). In addition, the model trainer 240 may adjust the correction error so that as the evaluation error between the evaluation labeled data and the reference labeled data decreases, the correction error between the corrected labeled data and the fusion track acquired from the vehicle 10 decreases.

For example, as illustrated in FIG. 6, the model trainer 240 may acquire corrected labeled data O₁, O₂, and O₃ from the trained second machine learning model. In addition, the model trainer 240 may acquire fusion tracks T₁, T₂, and T₃ acquired from the vehicle 10.

The model trainer 240 may acquire the correction error by comparing the corrected labeled data O₁, O₂, and O₃ with the fusion tracks T₁, T₂, and T₃, respectively. At this time, the model trainer 240 may adjust the correction error based on the evaluation error between the evaluation labeled data and the reference labeled data.

For example, the model trainer 240 may change data compared with the corrected labeled data O₁, O₂, and O₃ to adjusted labeled data L₁, L₂, and L₃ from the fusion tracks T₁, T₂, and T₃. The adjusted labeled data L₁, L₂, and L₃ may be positioned between one piece of the corrected labeled data O₁, O₂, and O₃ and one of the fusion tracks T₁, T₂, and T₃, respectively. The smaller the evaluation error between the evaluation labeled data and the reference labeled data, the closer the adjusted labeled data L₁, L₂, and L₃ may be to the corrected labeled data O₁, O₂, and O₃, respectively. In addition, the larger the evaluation error between the evaluation labeled data and the reference labeled data, the closer the adjusted labeled data L₁, L₂, and L₃ may be to the fusion tracks T₁, T₂, and T₃, respectively.

As described above, a reflection ratio of the fusion track acquired from the vehicle 10, that is, a weight of the fusion track, may decrease depending on the evaluation error between the evaluation labeled data and the reference labeled data. This is because the accuracy of the fusion track is fixed despite an increase in the amount of data, while the accuracy of the leveling data by the second machine learning model is improved according to the increase in the amount of data.

The transmitter 250 may provide the trained first machine learning model to the vehicle 10. For example, the transmitter 250 may be implemented as a transceiver, communicator, or communication device and may provide the trained first machine learning model to the vehicle 10 through a broadband communication network. As another example, the transmitter 250 may be implemented as a data recorder and may store the trained first machine learning model in a storage medium.

As described above, the server apparatus 200 may include the first machine learning model, the first training data, the second machine learning model, and the second training data. For example, the first machine learning model may output the LiDAR track corresponding to the input LiDAR data, and the first training data may include labeled LiDAR data for training the first machine learning model. The second machine learning model may output the labeled LiDAR data corresponding to the input LIDAR data, and the second training data may include the LiDAR data and the labeled data for training the second machine learning model. The second machine learning model trained by the second training data may be corrected using the LiDAR data and the image and radar fusion track acquired from the vehicle 10.

However, the server apparatus 200 is not limited thereto. The server apparatus 200 may include only the first machine learning model and the first training data.

For example, the server apparatus 200 may include one machine learning model for generating a track corresponding to detected data and training data for training the machine learning model. The server apparatus 200 may train the machine learning model using the training data. The training data may include the reference detected data and the labeled data.

In addition, the server apparatus 200 may receive the detected data (e.g., the image data, the radar data, or the LiDAR data) and the track (e.g., the image track, the radar track, the LiDAR track, or the fusion track) from the vehicle 10 in order to correct the trained machine learning model.

The server apparatus 200 may evaluate and correct the trained machine learning model using the training data. The server apparatus 200 may input the reference detected data to the trained machine learning model and acquire an evaluated track from the trained machine learning model. The server apparatus 200 may compare the evaluated track with the labeled data of the training data and correct the trained machine learning model based on the evaluation error between the evaluated track and the labeled data.

When the evaluation error between the evaluated track and the labeled data is smaller than or equal to the reference error, the server apparatus 200 may determine that the accuracy of the trained machine learning model is high.

When the evaluation error between the evaluated track and the labeled data is larger than the reference error, the server apparatus 200 may correct the trained machine learning model using the detected data and the track acquired from the vehicle 10.

The server apparatus 200 may input the detected data of the vehicle 10 to the trained machine learning model and acquire a corrected track from the trained machine learning model. The server apparatus 200 may compare the corrected track with the track of the vehicle 10 and correct the trained machine learning model based on the correction error between the corrected track and the track of the vehicle 10. For example, the server apparatus 200 may correct the trained machine learning model to reduce the correction error between the corrected track and the track of the vehicle 10.

In addition, the server apparatus 200 may adjust the correction of the trained machine learning model based on the evaluation error caused by the training data. For example, the server apparatus 200 may adjust the correction error between the corrected track and the track of the vehicle 10 on the basis of the evaluation error by the training data and correct the trained machine learning model based on the adjusted correction error.

In addition, the server apparatus 200 may provide the corrected machine learning model to the vehicle 10.

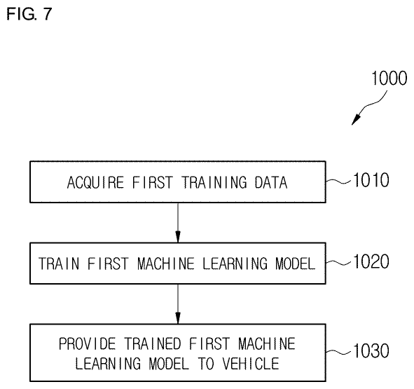

FIG. 7 is a flowchart for illustrating a method of training a machine learning model according to an embodiment of the present disclosure.

A method 1000 of training a first machine learning model will be described with reference to FIG. 7. Operations 1010, 1020, and 1030 included in the method 1000 in FIG. 7 may not be an essential operation of the method 1000, and one or some of operations 1010, 1020, and 1030 may be omitted from or may not be included in the method 1000.

At operation 1010, first training data may be acquired.

The first training data may include labeled detected data. For example, the labeled detected data may include labeled image data, labeled radar data, and/or labeled LiDAR data.

The labeled detected data may include detected data and labeled data corresponding to the detected data. For example, the labeled image data may include image data and labeled data corresponding to the image data, and the labeled radar data may include radar data and labeled data corresponding to the radar data. In addition, the labeled LiDAR data may include LiDAR data and labeled data corresponding to the LiDAR data.

For example, the server apparatus 200 may acquire the labeled LiDAR data using a second machine learning model. The second machine learning model may output the labeled data corresponding to the input LiDAR data, and the server apparatus 200 may acquire the labeled LiDAR data that is a combination of, or has, the LiDAR data and the labeled data.

At operation 1020, the first machine learning model may be trained.

The first machine learning model may be trained using the first training data.

The detected data (e.g., the image data, the radar data, or the LiDAR data) may be input to the first machine learning model, and the first machine learning model may output the track (e.g., the image track, the radar track, or the LiDAR track) corresponding to the input detected data.

The first machine learning model may be trained by the labeled detected data (e.g., the labeled image data, the labeled radar data, or the labeled LiDAR data). For example, the server apparatus 200 may input the detected data to the first machine learning model and compare the output track with the labeled data of the labeled detected data. In addition, the server apparatus 200 may modify or update the first machine learning model based on the error between the output track and the labeled data.

At operation 1030, the trained first machine learning model may be provided or output to the vehicle 10.

The trained first machine learning model may be provided or output from the server apparatus 200 to the vehicle 10 in various ways.

For example, the trained first machine learning model may be output or provided to the vehicle 10 via a network such as a wired and/or wireless communication network. As another example, the trained first machine learning model may be provided to the vehicle 10 through a storage medium or memory.

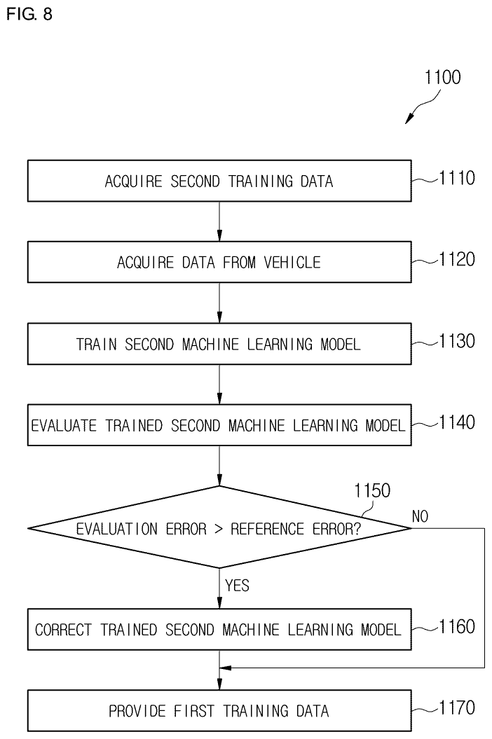

FIG. 8 is a flowchart for illustrating a method of labeling training data for training a machine learning model according to an embodiment of the present disclosure.

A method 1100 of training a second machine learning model will be described with reference to FIG. 8. Operations 1110 to 1170 included in the method 1100 in FIG. 8 may not be an essential configuration of the method 1100, and one or some of operations 1110 to 1170 may be omitted from or may not be included in the method 1100.

At operation 1110, second training data may be acquired.

The second training data may include detected data (e.g. image data, radar data, or LiDAR data) and reference labeled data corresponding to the detected data. For example, the second training data may be acquired by the labeling operation of humans.

At operation 1120, the detected data may be acquired from the vehicle 10.

The server apparatus 200 may receiver or acquire data from the vehicle 10 through a transceiver, communicator, communication network or storage medium.

For example, the server apparatus 200 may receive or acquire, from the vehicle 10, information about the detected data (e.g., the image data, the radar data, or the LiDAR data) collected by the vehicle 10 and the track (e.g., the image track, the radar track, or the LiDAR track) corresponding to the detected data. The server apparatus 200 may acquire the LiDAR data and the image and radar fusion track.

As another example, the server apparatus 200 may acquire the detected data collected by the vehicle 10 and the track by inputting the detected data to the first machine learning model or conventional program. The server apparatus 200 may receive the image data, the radar data, and the LiDAR data and acquire the image and radar fusion track by inputting the image data and the radar data to the first machine learning model.

At operation 1130, the second machine learning model may be trained.

The second machine learning model may be trained by the second training data. The detected data (e.g., the image data, the radar data, or the LiDAR data) may be input to the second machine learning model, and the second machine learning model may output the labeled data corresponding to the input detected data.

The second machine learning model may be trained by the detected data and the reference labeled data. For example, the server apparatus 200 may input the detected data to the first machine learning model and compare the output first labeled data with the reference labeled data. In addition, the server apparatus 200 may modify or update the second machine learning model based on an error between the first labeled data and the reference labeled data.

At operation 1140, the trained second machine learning model may be evaluated.

The trained second machine learning model may be evaluated by the second training data. For example, the server apparatus 200 may input the LiDAR data included in the second training data to the trained second machine learning model and acquire evaluation labeled data from the trained second machine learning model. The server apparatus 200 may compare the evaluation labeled data of the trained second machine learning model with the reference labeled data of the second training data and acquire an evaluation error between the evaluation labeled data of the trained second machine learning model and the reference labeled data of the second training data.

At operation 1150, whether the evaluation error is larger than a reference error may be identified.

The server apparatus 200 may compare the acquired evaluation error with the reference error and determine that the accuracy of the trained second machine learning model is high when the acquired evaluation error is smaller than or equal to the reference error. However, the server apparatus 200 may determine that the accuracy of the trained second machine learning model is low when the acquired evaluation error is larger than the reference error.

When it is determined that the evaluation error is larger than the reference error (YES in operation 1150), the trained second machine learning model may be corrected (operation 1160).

At operation 1160, when the acquired evaluation error is larger than the reference error, the server apparatus 200 may correct the trained second machine learning model using the detected data and/or track acquired from the vehicle 10.

For example, the server apparatus 200 may correct the trained second machine learning model using the LiDAR data and the fusion track (e.g., the track obtained by fusing the image data and the radar data) acquired from the vehicle 10.

The server apparatus 200 may input the LiDAR data acquired from the vehicle 10 to the trained second machine learning model and acquire the corrected labeled data from the trained second machine learning model. The server apparatus 200 may compare the corrected labeled data of the trained second machine learning model with the fusion track and correct the trained second machine learning model to reduce the correction error between the corrected labeled data and the fusion track.

After the trained second machine learning model is corrected or when it is determined that the evaluation error is not larger than the reference error (NO in operation 1150), the first training data may be provided (operation 1170).

The server apparatus 200 may input the detected data acquired from the vehicle 10 to the second machine learning model and acquire the labeled detected data corresponding to the detected data from the second machine learning model. The labeled detected data may be used as the first training data for training the first machine learning model.

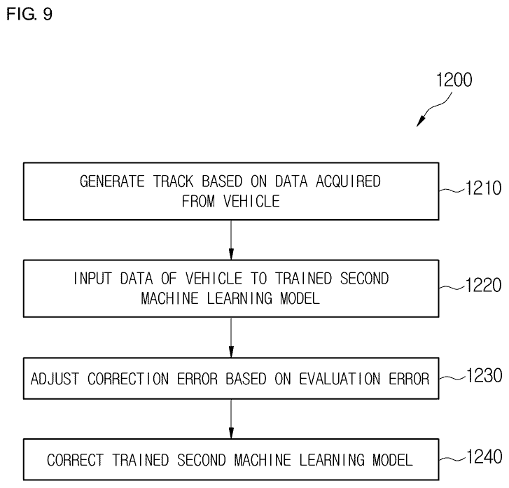

FIG. 9 is a flowchart for illustrating a method of labeling training data for training a machine learning model according to an embodiment of the present disclosure.

A method 1200 of training a second machine learning model will be described with reference to FIG. 9. Operations 1210, 1220, 1230, and 1240 included in the method 1200 may not be an essential operation of the method 1200, and one or some of operations 1210, 1220, 1230, and 1240 may be omitted from or may not be included in the method 1200 of FIG. 9.

At operation 1210, a track may be acquired from data received or acquired from the vehicle 10.

The server apparatus 200 may acquire information about detected data and the track, or acquire the detected data from the vehicle 10.

For example, the server apparatus 200 may acquire information about LiDAR data and an image and radar fusion track (e.g., a track obtained by fusing image data and radar data) from the vehicle 10.

As another example, the server apparatus 200 may acquire the image data, the radar data, and the LiDAR data. The server apparatus 200 may acquire the image and radar fusion track by fusing the image data and the radar data.

At operation 1220, the data of the vehicle may be input to the trained second machine learning model.

The server apparatus 200 may input the acquired detected data to the trained second machine learning model. The trained second machine learning model may output the corrected labeled data corresponding to the input detected data.

The server apparatus 200 may compare the corrected labeled data of the trained second machine learning model with the fusion track and acquire a correction error between the corrected labeled data and the fusion track.

At operation 1230, the correction error may be adjusted based on the evaluation error.

The evaluation error may be acquired through operation 1140 described with reference to FIG. 8.

The correction error for correcting the trained second machine learning model may be corrected by the evaluation error acquired in operation 1140 of FIG. 8.

For example, the server apparatus 200 may adjust the correction error so that as the evaluation error between the evaluation labeled data and the reference labeled data, the correction error between the corrected labeled data and the fusion track acquired from the vehicle 10 increases (e.g., so that the correction error becomes closer to the original error between the corrected labeled data and the fusion track acquired from the vehicle 10). In addition, the server apparatus 200 may adjust the correction error so that as the evaluation error between the evaluation labeled data and the reference labeled data decreases, the correction error between the corrected labeled data and the fusion track acquired from the vehicle 10 decreases.

At operation 1240, the trained second machine learning model may be corrected.

The server apparatus 200 may correct the trained second machine learning model based on the corrected correction error. The server apparatus 200 may correct the trained second machine learning model to reduce the corrected correction error.

Therefore, according to one aspect of the present disclosure, it is possible to provide a server apparatus for driving assistance for acquiring object information from LIDAR data, and a method of controlling the same.

According to another aspect of the present disclosure, it is possible to provide a server apparatus for driving assistance, which can train a machine learning model using image data, radar data, LiDAR data, and/or sensor fusion data, and a method of controlling the same.

According to still another aspect of the present disclosure, it is possible to provide a server apparatus for driving assistance for acquiring object information from LIDAR data using a machine learning model trained using image data, radar data, LiDAR data, and/or sensor fusion data, and a method of controlling the same.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A server apparatus comprising:
a communicator configured to communicate with a vehicle;
memory configured to store a first machine learning model, a second machine learning model, first training data, and second training data; and
one or more processors configured to:
acquire the second training data including reference data and reference labeled data corresponding to the reference data;
train the second machine learning model using the second training data including the reference data and the reference labeled data;
receive detected data and a detected track corresponding to the detected data from the vehicle;
correct the trained second machine learning model using the detected data and the detected track received from the vehicle;
acquire the first training data using the corrected trained second machine learning model;
train the first machine learning model using the first training data acquired using the trained second machine learning model corrected using the detected data and the detected track received from the vehicle; and
output the trained first machine learning model to the vehicle.

2. The server apparatus of claim 1, wherein the one or more processors are configured to:
input the reference data of the second training data to the second machine learning model;
acquire first labeled data corresponding to the input reference data of the second training data from the second machine learning model; and
train the second machine learning model to reduce an error between the first labeled data acquired from the second machine learning model and the reference labeled data included in the second training data.

3. The server apparatus of claim 1, wherein the one or more processors are configured to:
input the reference data of the second training data to the second machine learning model trained to reduce the error between the first labeled data acquired from the second machine learning model and the reference labeled data included in the second training data;
acquire evaluation labeled data corresponding to the reference data of the second training data from the second machine learning model trained reduce the error between the first labeled data acquired from the second machine learning model and the reference labeled data included the second training data; and
correct the trained second machine learning model when an error between the evaluation labeled data acquired from the trained second machine learning model and the reference labeled data included in the second training data is larger than a reference error.

4. The server apparatus of claim 3, wherein the one or more processors are configured to acquire the first training data using the second machine learning model trained to reduce the error between the first labeled data acquired from the second machine learning model and the reference labeled data included in the second training data when the error between the evaluation labeled data acquired from the trained second machine learning model and the reference labeled data included in the second training data is smaller than or equal to the reference error.

5. The server apparatus of claim 3, wherein the one or more processors are configured to:
input the detected data, received from the vehicle, to the second machine learning model trained to reduce the error between the first labeled data acquired from the second machine learning model and the reference labeled data included in the second training data;
acquire correction labeled data corresponding to the detected data, received from the vehicle, from the second machine learning model trained to reduce the error between the first labeled data acquired from the second machine learning model and the reference labeled data included in the second training data; and
correct the second machine learning model, trained to reduce the error between the first labeled data acquired from the second machine learning model and the reference labeled data included in the second training data, to reduce a correction error between the correction labeled data acquired from the trained second machine learning model and the detected track received from the vehicle.

6. The server apparatus of claim 5, wherein the one or more processors are configured to adjust the correction error between the correction labeled data acquired from the trained second machine learning model and the detected track received from the vehicle based on the error between the evaluation labeled data acquired from the trained second machine learning model and the reference labeled data included in the second training data.

7. The server apparatus of claim 6, wherein the one or more processors are configured to adjust the correction error between the correction labeled data acquired from the trained second machine learning model and the detected track received from the vehicle so that the correction error between the correction labeled data acquired from the trained second machine learning model and the detected track received from the vehicle increases as the error between the evaluation labeled data acquired from the trained second machine learning model and the reference labeled data included in the second training data increases and the correction error between the correction labeled data acquired from the trained second machine learning model and the detected track received from the vehicle decreases as the evaluation error between the evaluation labeled data acquired from the trained second machine learning model and the reference labeled data included in the second training data decreases.

8. A method of controlling a server apparatus including a communicator configured to communicate with a vehicle and memory configured to store a first machine learning model, a second machine learning model, first training data, and second training data, the method comprising:
acquiring the second training data including reference data and reference labeled data corresponding to the reference data;
training the second machine learning model using the second training data including the reference data and the reference labeled data;
receiving detected data and a detected track corresponding to the detected data from the vehicle;
correcting the trained second machine learning model using the detected data and the detected track received from the vehicle;
acquiring the first training data using the corrected trained second machine learning model;
training the first machine learning model using the first training data acquired using the trained second machine learning model corrected using the detected data and the detected track received from the vehicle; and
outputting the trained first machine learning model to the vehicle.

9. The method of claim 8, wherein the training of the second machine learning model includes:
inputting the reference data of the second training data to the second machine learning model;
acquiring first labeled data corresponding to the input reference data of the second training data from the second machine learning model; and
training the second machine learning model to reduce an error between the first labeled data acquired from the second machine learning model and the reference labeled data included in the second training data.

10. The method of claim 8, further comprising evaluating the second machine learning model, wherein the evaluating of the second machine learning model includes:
inputting the reference data of the second training data to the second machine learning model trained to reduce the error between the first labeled data acquired from the second machine learning model and the reference labeled data included in the second training data;
acquiring evaluation labeled data corresponding to the reference data of the second training data from the second machine learning model trained reduce the error between the first labeled data acquired from the second machine learning model and the reference labeled data included in the second training data; and
correcting the trained second machine learning model when an error between the evaluation labeled data acquired from the trained second machine learning model and the reference labeled data included in the second training data is larger than a reference error.

11. The method of claim 10, further comprising acquiring the first training data using the second machine learning model trained to reduce the error between the first labeled data acquired from the second machine learning model and the reference labeled data included in the second training data when the error between the evaluation labeled data acquired from the trained second machine learning model and the reference labeled data included in the second training data is smaller than or equal to the reference error.

12. The method of claim 10, wherein the correcting of the trained second machine learning model includes:
inputting the detected data, received from the vehicle, to the second machine learning model trained to reduce the error between the first labeled data acquired from the second machine learning model and the reference labeled data included in the second training data;
acquiring correction labeled data corresponding to the detected data, received from the vehicle, from the second machine learning model trained to reduce the error between the first labeled data acquired from the second machine learning model and the reference labeled data included in the second training data; and
correcting the second machine learning model, trained to reduce the error between the first labeled data acquired from the second machine learning model and the reference labeled data included in the second training data, to reduce a correction error between the correction labeled data acquired from the trained second machine learning model and the detected track received from the vehicle.

13. The method of claim 12, wherein the correcting of the trained second machine learning model includes adjusting the correction error between the correction labeled data acquired from the trained second machine learning model and the detected track received from the vehicle based on the error between the evaluation labeled data acquired from the trained second machine learning model and the reference labeled data included in the second training data.

14. The method of claim 13, wherein the adjusting of the correction error includes adjusting the correction error between the correction labeled data acquired from the trained second machine learning model and the detected track received from the vehicle so that the correction error between the correction labeled data acquired from the trained second machine learning model and the detected track received from the vehicle increases as the error between the evaluation labeled data acquired from the trained second machine learning model and the reference labeled data included in the second training data increases and the correction error between the correction labeled data acquired from the trained second machine learning model and the detected track received from the vehicle decreases as the error between the evaluation labeled data acquired from the trained second machine learning model and the reference labeled data included in the second training data decreases.

15. A server apparatus comprising:
a communicator configured to communicate with a vehicle;
memory configured to store a machine learning model and training data; and
one or more processors configured to:
acquire the training data including reference data and labeled data corresponding to the reference data;
train the machine learning model using the training data including the reference data and the labeled data;
receive detected data and a detected track corresponding to the detected data from the vehicle;
evaluate the trained machine learning model using the training data including the reference data and the labeled data;
correct the machine learning model using the detected data and the detected track, received from the vehicle, based on the evaluating of the trained machine learning model using the training data; and
output the corrected machine learning model to the vehicle.

16. The server apparatus of claim 15, wherein the one or more processors are configured to:
input the reference data of the training data to the machine learning model;
acquire a training track corresponding to the reference data of the training data from the machine learning model; and
train the machine learning model to reduce an error between the training track acquired from the machine learning model and the labeled data included in the training data.

17. The server apparatus of claim 16, wherein the one or more processors are configured to:
input the reference data of the training data to the machine learning model trained to reduce the error between the training track acquired from the machine learning model and the labeled data included in the training data;
acquire an evaluated track corresponding to the reference data of the training data from the machine learning model trained to reduce the error between the training track acquired from the machine learning model and the labeled data included in the training data; and
correct the machine learning model trained to reduce the error between the training track acquired from the machine learning model and the labeled data included in the training data when an evaluation error between the evaluated track acquired from the machine learning model and the labeled data included in the training data is larger than a reference error.

18. The server apparatus of claim 17, wherein the one or more processors are configured to:
input the detected data, received from the vehicle, to the machine learning model trained to reduce the error between the training track acquired from the machine learning model and the labeled data included in the training data;
acquire a corrected track corresponding to the detected data, received from the vehicle, from the machine learning model trained to reduce the error between the training track acquired from the machine learning model and the labeled data included in the training data; and
correct the machine learning model trained to reduce the error between the training track acquired from the machine learning model and the labeled data included in the training data to reduce a correction error between the corrected track acquired from the trained machine learning model and the detected track received from the vehicle.

19. The server apparatus of claim 18, wherein the one or more processors are configured to adjust the correction error between the corrected track acquired from the trained machine learning model and the detected track received from the vehicle based on the evaluation error between the evaluated track acquired from the machine learning model and the labeled data included in the training data.

20. The server apparatus of claim 19, wherein the one or more processors are configured to adjust the correction error between the corrected track acquired from the trained machine learning model and the detected track received from the vehicle so that the correction error increases as the evaluation error between the evaluated track acquired from the machine learning model and the labeled data included in the training data increases, and the correction error between the corrected track acquired from the trained machine learning model and the detected track received from the vehicle decreases as the evaluation error between the evaluated track acquired from the machine learning model and the labeled data included in the training data decreases.
